(19) United States
(12) Patent Application Publication
(10) Pub. No.: US 2025/0373185 A1
(43) Pub. Date: Dec. 4, 2025

(54) Controller for a Battery-Powered Permanent Magnet Synchronous Motor

(71) Applicant: Infineon Technologies Austria AG, Villach (AT)

(72) Inventors: Vedant Sadashiv Chendake, Singapore (SG); Mitradatta Misra, Orissa (IN); Song Lin, Singapore (SG)

(21) Appl. No.: 18/731,553

(22) Filed: Jun. 3, 2024

(51) Int. Cl. H02P 21/24; H02J 7/00; H02P 21/14; H02P 21/20

(52) U.S. Cl. CPC H02P 21/24; H02J 7/0063; H02P 21/141; H02P 21/20

(57) ABSTRACT

A controller for a battery-powered PMSM (permanent magnet synchronous motor) is described. In one embodiment, the controller includes: a first controller configured to generate a flux generating voltage reference for the PMSM; a second controller configured to generate a torque generating voltage reference for the PMSM; and a battery capacity adjustment factor configured to adjust the flux generating voltage reference and the torque generating voltage reference, based on capacity of the battery. In another embodiment, the controller includes: a rotor position estimator configured to estimate a rotor electrical angle and a rotor electrical speed of the PMSM, based on a flux generating voltage reference for the PMSM, a torque generating voltage reference for the PMSM, a flux generating current feedback for the PMSM, and a torque generating current feedback for the PMSM, the rotor position estimator including a speed feedforward term. The controller embodiments are not necessarily mutually exclusive.

### BACKGROUND

FOC (field oriented control) is widely used in motor control applications because of advantageous characteristics such as improved performance, especially for PMSM (permanent magnet synchronous motor) applications. However, in battery-powered multi-phase PMSM sensorless drive applications, such as power drills, the battery voltage can drop significantly during start-up for various reasons. For example, a relatively high start-up acceleration rate can lead to a torque demand rate that is higher than time constant of the system. A relatively low battery Amp-hour rating and lower initial state-of-charge leads to insufficient current to meet the torque demand. Deviation of the initial rotor position estimate from the actual rotor position leads to a longer position estimation convergence time. In closed loop estimation, which uses a PLL (phase lock loop) observer/estimator, integral saturation of the PLL leads to a larger position estimation error and hence longer convergence time. The battery voltage also can drop significantly during transients with sharp load change. A steep drop in the dc-voltage can trigger dc-link under-voltage protection, leading to a start-up failure. Each of these scenarios can lead to start-up acceleration failure in sensorless PMSM drives, predominantly due to inherent delay in PLL observer/estimator convergence and unaccounted drop in battery voltage.

Thus, there is a need for improved control technique for battery-powered sensorless PMSM drives.

### SUMMARY

According to an embodiment of a controller for a battery-powered PMSM (permanent magnet synchronous motor), the controller comprises: a first controller configured to generate a flux generating voltage reference for the PMSM; a second controller configured to generate a torque generating voltage reference for the PMSM; and a battery capacity adjustment factor configured to adjust the flux generating voltage reference and the torque generating voltage reference, based on capacity of the battery.

According to another embodiment of a controller for a battery-powered PMSM, the controller comprises: a rotor position estimator configured to estimate a rotor electrical angle and a rotor electrical speed of the PMSM, based on a flux generating voltage reference for the PMSM, a torque generating voltage reference for the PMSM, a flux generating current feedback for the PMSM, and a torque generating current feedback for the PMSM, wherein the rotor position estimator comprises a speed feedforward term.

The controller embodiments are not necessarily mutually exclusive. That is, the battery capacity adjustment factor feature and the speed feedforward feature may be used exclusive to one another or in combination.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a block diagram of a controller for a PMSM (permanent magnet synchronous motor) powered by a battery.

FIG. 2 illustrates a simplified d-q axis model for the PMSM.

FIG. 3 illustrates a d axis equivalent circuit of the PMSM.

FIG. 4 illustrates a q axis equivalent circuit of the PMSM.

FIG. 5 illustrates an embodiment of a control block for implementing a speed feedforward term of the controller.

FIG. 6 illustrates a simplified stator equivalent circuit model for the PMSM.

FIG. 7 illustrates another embodiment of a control block for implementing the speed feedforward term of the controller, and which is based on the simplified stator equivalent circuit model shown in FIG. 6.

FIG. 8 illustrates a simplified model of the battery, which has an almost linear inverse cell voltage to current relationship.

FIG. 9 illustrates the DC current and the DC voltage for the simplified battery model during fast start-up acceleration of the PMSM, and the corresponding rotor electrical speed of the PMSM.

### DETAILED DESCRIPTION

Described herein are controller embodiments that enable fast and reliable start-up acceleration of multi-phase PMSM (permanent magnet synchronous motor) drives, operating in sensorless FOC mode. The controller embodiments include a battery capacity adjustment factor feature and a speed feedforward feature that both mitigate the delay in PLL observer/estimator convergence and unaccounted drop in battery voltage. The battery capacity adjustment factor feature and the speed feedforward feature may be used exclusive to one another or in combination.

Described next, with reference to the figures, are exemplary controller embodiments.

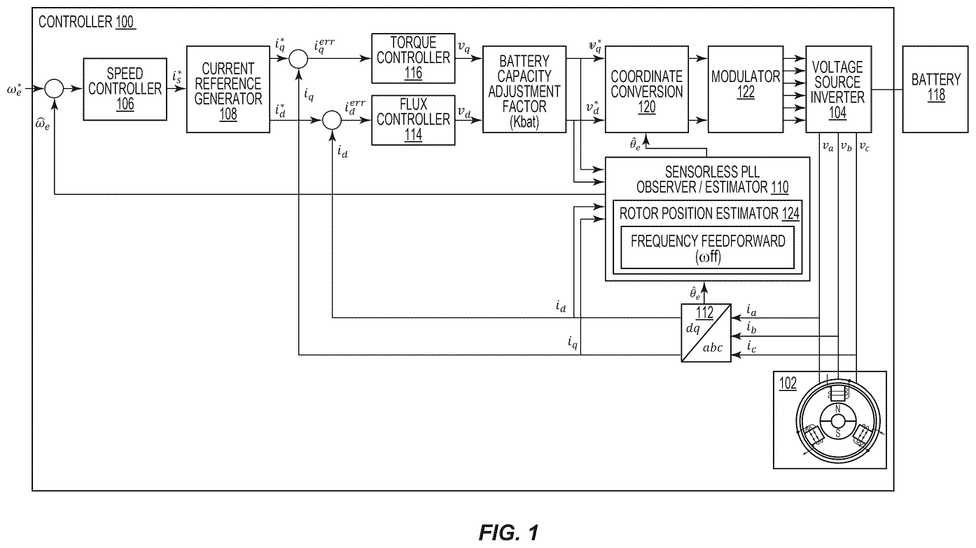

FIG. 1 illustrates a block diagram of a controller 100 for a PMSM 102. In FIG. 1, the PMSM 102 is depicted as having three phases: a, b, and c. More generally, the PMSM 102 can have two or more phases. A voltage source inverter (VSI) 104 translates each phase command generated by the controller 100 into a corresponding motor phase voltage un.

In FIG. 1, the controller 100 includes a speed controller 106 which can include, e.g., one or more PI (proportional-integral) controllers, PID (proportional-integral-derivative) controllers filters, etc. The speed controller 106 generates a current command is that is input to a current reference generator 108. The speed controller 106 generates the current

$${i}_{s}^{*}$$

based on a reference motor speed

$${ω}_{e}^{*}$$

and a rotor electrical speed estimate \hat{ω}ₑ generated by a sensorless PLL observer/estimator 110. The sensorless PLL observer/estimator 110 is a control loop designed to estimate or ‘observe’ internal variables of the motor system such as rotor electrical speed we and rotor electrical angle θ without directly measuring the variables.

The current command

$${i}_{s}^{*}$$

generated by the speed controller 106 is a complex current space vector which can be defined in the d, q coordinate system, where the d (direct) axis is the axis by which flux is produced by the permanent magnet and i_{d} current, and the q (quadrature) axis is the axis on which torque is produced. The current reference generator 108 converts the current command

$${i}_{s}^{*}$$

into orthogonal components along the d and q axes, such that a flux generating current

$${i}_{d}^{*}$$

is aligned along the d axis and a torque generating current

$${i}_{q}^{*}$$

is aligned along the q axis. The current reference generator 108 may generate the flux generating current

$${i}_{d}^{*}$$

and the torque generating current

$${i}_{q}^{*}$$

using, e.g., a maximum torque per ampere (MTPA) algorithm, a maximum torque per volt (MTPV) algorithm, a flux-weakening algorithm, etc.

A current reconstruction logic 112 converts the motor phase currents iₐ, i_{b}, i_{c} into a flux (d axis) generating current feedback i_{d} for the PMSM 102 and a torque (q axis) generating current feedback i_{q} for the PMSM 102. The difference between the flux generating current

$${i}_{d}^{*}$$

generated by the current reference generator 108 and the flux generating current feedback i_{d} for the PMSM 102 is input to a flux controller 114 as a flux error signal

$${i}_{d}^{e r r} .$$

The difference between the torque generating current

$${i}_{q}^{*}$$

generated by the current reference generator 108 and the torque generating current feedback i_{q} for the PMSM 102 is input to a torque controller 116 as a torque signal

$${i}_{q}^{e r r} .$$

The flux controller 114 generates a flux generating voltage reference v_{d} for the PMSM 102, based on the flux error signal

$${i}_{d}^{e r r} .$$

The torque controller 116 generates a torque generating voltage reference v_{q} for the PMSM 102, based on the torque error signal

$${i}_{q}^{e r r} .$$

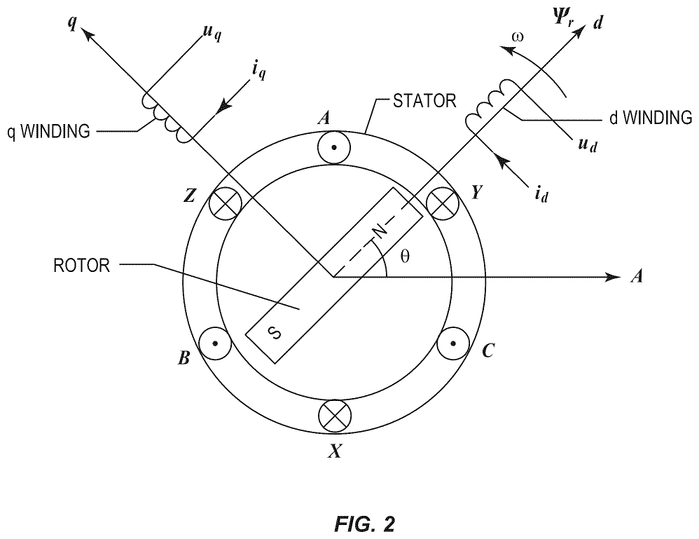

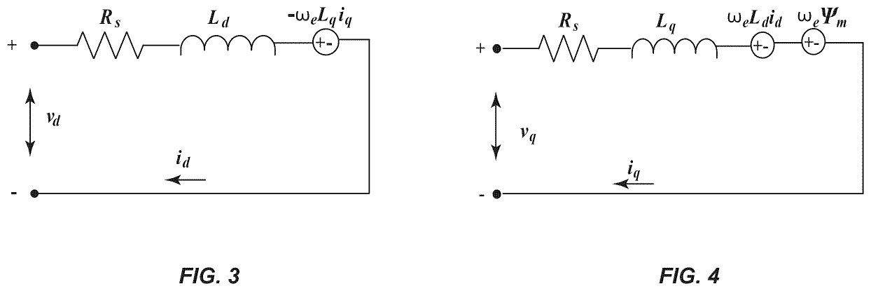

The flux controller 114 and the torque controller 116 are described in more detail next in connection with FIGS. 2 through 4. FIG. 2 illustrates a simplified d-q axis model for the PMSM 102. FIG. 3 illustrates a d axis equivalent circuit of the PMSM 102. FIG. 4 illustrates a q axis equivalent circuit of the PMSM 102.

The flux controller 114 may generate the flux generating voltage reference v_{d} for the PMSM 102 that has the following relationship:

$${v}_{d} = {R}_{s} {i}_{d} - {ω}_{e} {L}_{q} {i}_{q} + {L}_{d} \frac{d {i}_{d}}{d t} \qquad ( 1 )$$

and the torque controller 116 may generate the torque generating voltage reference v_{q} for the PMSM 102 has the following relationship:

$${v}_{q} = {R}_{s} {i}_{q} + {ω}_{e} {L}_{d} {i}_{d} + {L}_{q} \frac{d {i}_{q}}{d t} + {ω}_{e} {ψ}_{m} \qquad ( 2 )$$

where,
Rs: motor phase resistance,
\hat{ω}ₑ: rotor electrical speed estimate,
Ld: synchronous inductance of motor winding in d-axis,
Lq: synchronous inductance of motor winding in q-axis, and
ψₘ: permanent magnet flux linkage constant.

Since the flux generating current feedback i_{d} and the torque generating current feedback i_{q} for the PMSM 102 are predominantly DC with some additional harmonics, the corresponding derivatives may be considered negligible under steady-state. Accordingly, flux generating voltage equation (1) can be simplified as follows:

$${v}_{d} - {R}_{s} {i}_{d} + {ω}_{e} {L}_{q} {i}_{q} = 0 \qquad ( 3 )$$

and torque generating voltage equation (2) can be simplified as follows:

$${v}_{q} - {R}_{s} {i}_{q} - {ω}_{e} {L}_{d} {i}_{d} = {ω}_{e} {ψ}_{m} . \qquad ( 4 )$$

The sensorless PLL observer/estimator 110 maintains equation (3) at zero, e.g., through a PI control loop.

In FIG. 1, the motor controller 100 also includes a battery capacity adjustment factor K_{bat} that adjusts both the flux generating voltage reference v_{d} and the torque generating voltage reference v_{q}, based on the capacity of the battery 118 that powers the PMSM 102. For example, to account for the battery capacity, the drop in battery voltage may be viewed as a direct representation of the battery capacity based on the battery rating and initial state-of-charge. According to this embodiment, also referred to herein as the battery capacity adjustment factor feature, the flux generating voltage reference v_{d} and the torque generating voltage reference v_{q} are adjusted based on feedback of the battery voltage V_{bat}. This allows the demand placed on the battery 118 to gradually adjust based on the ability of the battery 118 to meet the current demand of the PMSM 102, instead of a hard constraint based on a supply current limit.

To account for the battery capacity limits on start-up acceleration, the battery capacity adjustment factor K_{bat} may be calculated as a measured voltage V_{bat} of the battery 118 divided by a nominal voltage Vnom of the battery 118, as follows:

$${K}_{b a t} = \frac{{V}_{b a t}}{{V}_{n o m}} . \qquad ( 5 )$$

The battery capacity adjustment calculation in equation (5) assumes that the instantaneous battery voltage, when subjected to a sudden load, is directly affected by the battery capacity based on the Ampere-hour rating and initial state-of-charge of the battery 118. The battery capacity adjustment factor K_{bat} is multiplied with the both the flux generating voltage reference v_{d} and the torque generating voltage reference v_{q} from the torque and flux controllers, respectively, and provided as input to the sensorless PLL observer/estimator 110 and to a modulation stage of the controller 100.

The adjusted reference voltages may be calculated as follows:

$${v}_{d}^{*} = {K}_{b a t} {v}_{d} \qquad ( 6 )$$

$${v}_{q}^{*} = {K}_{b a t} {v}_{q} \qquad ( 7 )$$

$${v}_{s}^{*} = {K}_{b a t} \sqrt{{( {v}_{d}^{*} )}^{2} + {( {v}_{q}^{*} )}^{2}} \qquad ( 8 )$$

where

$${v}_{d}^{*}$$

is the adjusted flux generating voltage reference

$${v}_{q}^{*}$$

is the adjusted torque generating voltage reference, and

$${v}_{s}^{*}$$

is a scaled estimate of the stator input voltage vₛ of the PMSM 102.

The modulation stage of the controller 100 may include coordinate conversion logic 120 to convert the d and q axis adjusted voltage references

$${v}_{d}^{*} , {v}_{q}^{*}$$

from the d-q axis to, e.g., a corresponding SRF (stationary-reference-frame) and then, e.g., from Cartesian SRF coordinates to polar coordinates. Other conversion algorithms may be used. More generally, the d and q axis adjusted voltage references

$${v}_{d}^{*} , {v}_{q}^{*}$$

may be converted to any suitable coordinate system compatible with a modulator 122 used to actuate the voltage source inverter 104. The modulator 122 may implement, e.g., DPWM (discontinuous pulse-width modulation), SVMPWM (space vector modulation pulse-width modulation), etc.

In FIG. 1, the sensorless PLL observer/estimator 110 includes or implements a rotor position estimator 124 that estimates the rotor electrical angle θ and the rotor electrical speed we of the PMSM 102. The rotor electrical angle estimate \hat{θ}ₑ and the rotor electrical speed estimate \hat{ω}ₑ are determined based on the adjusted flux generating voltage reference

$${v}_{d}^{*} ,$$

the adjusted torque generating voltage reference

$${v}_{q}^{*} ,$$

the flux generating current feedback i_{d} for the PMSM 102, and the torque generating current feedback i_{q} for the PMSM 102.

The rotor position estimator 124 may also include a speed feedforward term ‘ω_{ff}’. According to this embodiment, also referred to herein as the speed feedforward feature, the speed feedforward term ω_{ff} may be based on the stator back-emf and provides an instantaneous estimate of the rotor position even before the sensorless PLL observer/estimator 110 has reached steady-state. This enables faster acceleration, which would otherwise not be possible with conventional PLL-based sensorless control or rotor position estimator. The battery capacity adjustment factor feature and the speed feedforward feature may be used exclusive to one another or in combination.

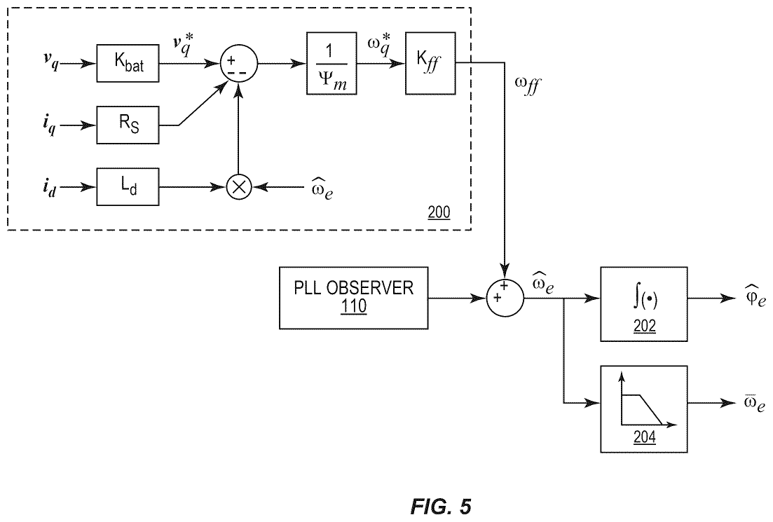

FIG. 5 illustrates an embodiment of a control block 200 for implementing the speed feedforward term ω_{ff}. In FIG. 5, the speed feedforward term ω_{ff} includes a weighting factor K_{ff} that is in a range of zero (0) to less than one (1), e.g., 0.5. The weighting factor K_{ff} may be user configurable.

As shown in FIG. 5 and in accordance with equation (9), the speed feedforward term ω_{ff} may include a dynamic component

$${ω}_{q}^{*}$$

that is calculated based on the adjusted torque generating voltage reference

$${v}_{q}^{*} ,$$

the phase resistance Rₛ of the PMSM, the torque generating current feedback i_{q}, the rotor electrical speed estimate \hat{ω}ₑ, the synchronous inductance L_{d} of the PMSM, the flux generating current feedback i_{d}, and the permanent magnet flux linkage constant ψₘ for the PMSM. The dynamic component

$${ω}_{q}^{*}$$

is then weighted by the weighting factor K_{ff} to yield the speed feedforward term ω_{ff} in this example, as follows:

$${ω}_{ff} = {K}_{ff} \frac{{v}_{q}^{*} - {R}_{s} {i}_{q} - {ω}_{e} {L}_{d} {i}_{d}}{{ψ}_{m}} \qquad ( 9 )$$

In FIG. 5, the torque generating voltage reference v_{q} provided by the torque controller 116 is multiplied by the battery capacity adjustment factor K_{bat} to generate the adjusted torque generating voltage reference

$${v}_{q}^{*} .$$

However, scaling the torque generating voltage reference v_{q} by the battery capacity adjustment factor K_{bat} is optional. For example,

$${v}_{q}^{*}$$

may be replaced v_{q} in equation (9) which excludes the battery capacity adjustment factor K_{bat} in the calculation of the speed feedforward term ω_{ff}, as another example.

Also as shown in FIG. 5, the output of the sensorless PLL observer/estimator 110 is combined with the speed feedforward term ω_{ff} to generate the rotor electrical speed estimate \hat{ω}ₑ. The rotor electrical speed estimate \hat{ω}ₑ may then be integrated by an integrator 202 to yield the rotor electrical angle estimate \hat{θ}ₑ. The rotor electrical speed estimate \hat{ω}ₑ also may be passed through a low-pass filter 204 to yield a filtered version ω̅ₑ of the rotor electrical speed estimate \hat{ω}ₑ.

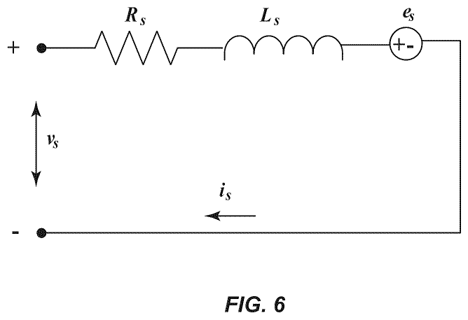

Calculating the feedforward term ω_{ff} in accordance with equation (9) is observed to mitigate the delay in PLL observer/estimator convergence and unaccounted drop in battery voltage. However, using the rotor electrical speed estimate \hat{ω}ₑ to calculate the feedforward term ωff in equation (9) may result in limited accuracy during the initial PLL locking period. An alternative approach for determining the speed feedforward term ω_{ff} is described next and based on the simplified stator equivalent circuit model shown in FIG. 6.

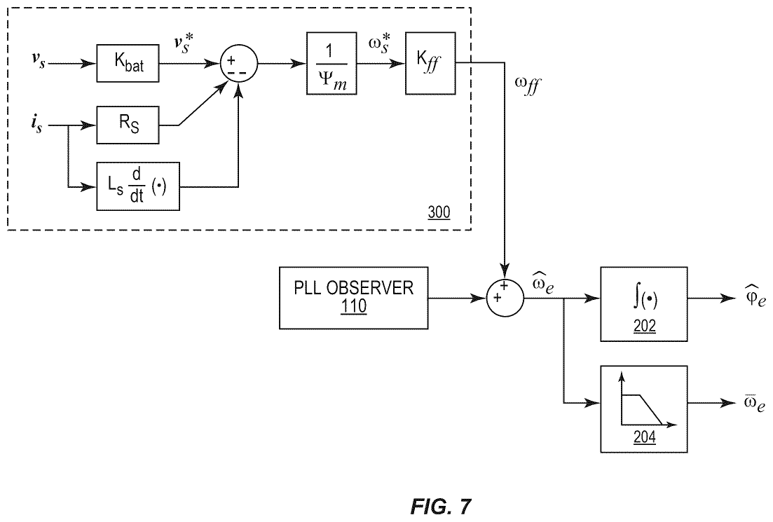

FIG. 7 illustrates another embodiment of a control block 300 for implementing the speed feedforward term ω_{ff}, and which is based on the simplified stator equivalent circuit model shown in FIG. 6. According to this embodiment, the speed feedforward term ω_{ff} includes a dynamic component

$${ω}_{s}^{*}$$

calculated based on a stator input voltage estimate vₛ for the PMSM, the phase resistance Rₛ of the PMSM, the stator current feedback iₛ for the PMSM, the stator inductance Lₛ of the PMSM, and the permanent magnet flux linkage constant ψₘ for the PMSM. The dynamic component

$${ω}_{s}^{*}$$

is then weighted by the weighting factor K_{ff} to yield the speed feedforward term ω_{ff} in this example, as follows.

$${ω}_{ff} = {K}_{ff} \frac{{v}_{s} - {R}_{s} {i}_{s} - {L}_{s} \frac{{di}_{s}}{dt}}{{ψ}_{m}} \qquad ( 10 )$$

The stator voltage eₛ for the simplified stator equivalent circuit model in FIG. 6 may be represented as follows:

$${e}_{s} = {v}_{s} - {R}_{s} {i}_{s} - {L}_{s} \frac{{di}_{s}}{dt} where , \qquad ( 11 )$$

$${v}_{s} = \sqrt{{v}_{d}^{2} + {v}_{q}^{2}} : stator input voltage , \qquad ( 12 )$$

$${i}_{s} = \sqrt{{i}_{d}^{2} + {i}_{q}^{2}} : stator current , \qquad ( 13 )$$

$${L}_{s} \approx \frac{{L}_{d} + {L}_{q}}{2} : stator inductance , and \qquad ( 14 )$$

$${e}_{s} \approx {ω}_{e} {ψ}_{m} : stator back emf . \qquad ( 15 )$$

The speed feedforward term ω_{ff} may be derived directly from the simplified stator voltage expression of equations (11) through (15), using equation (10). As explained above, 0<K_{ff}<1 is the weight given to the feedforward term ω_{ff} in the overall speed estimate.

As shown in FIG. 7, the effect of battery capacity limits on start-up acceleration may be accounted for in the calculation of the speed feedforward term ω_{ff} by multiplying the stator input voltage estimate vₛ by the battery capacity adjustment factor K_{bat} to generate an adjusted stator input voltage estimate

$${v}_{s}^{*} .$$

However, scaling the stator input voltage estimate vₛ by the battery capacity adjustment factor K_{bat} is optional, as indicated by equation (10) which excludes the battery capacity adjustment factor K_{bat} in the calculation of the speed feedforward term ω_{ff}, as another example.

If the battery capacity adjustment factor feature is used in combination with the q axis back-emf speed feedforward estimation process represented by equation (9), then the flux generating voltage reference v_{d} and the torque generating voltage reference v_{q} are scaled by the battery capacity adjustment factor K_{bat} as indicated in equations (6) and (7), respectively. In this q axis back-emf estimation example, the speed feedforward term ω_{ff} in equation (9) becomes:

$${ω}_{ff} = {K}_{ff} \frac{{v}_{q}^{*} - {R}_{s} {i}_{q} - {ω}_{e} {L}_{d} {i}_{d}}{{ψ}_{m}} \qquad ( 16 )$$

If the battery capacity adjustment factor feature is used in combination with the stator back-emf speed feedforward estimation process represented by equation (10), then the scaled stator input voltage estimate

$${v}_{s}^{*}$$

may be determined as indicated by equation (8). That is, the scaled stator input voltage estimate

$${v}_{s}^{*}$$

for the PMSM 102 may be calculated based on the adjusted flux generating voltage reference

$${v}_{d}^{*} ,$$

the adjusted torque generating voltage reference

$${v}_{q}^{*} ,$$

and the battery capacity adjustment factor V_{bat}. In this stator back-emf estimation example, the speed feedforward term ωff in equation (10) becomes:

$${ω}_{ff} = {K}_{ff} \frac{{v}_{s}^{*} - {R}_{s} {i}_{s} - {L}_{s} \frac{{di}_{s}}{dt}}{{ψ}_{m}}$$

Both the q axis back-emf estimation approach and the stator back-emf estimation approach in combination with the battery capacity adjustment factor feature ensure that the voltage demand of the PMSM 102 is proportionally decreased based on the instantaneous battery voltage, instead of pulling the battery 118 into a deep discharge state until the supply current limit is hit.

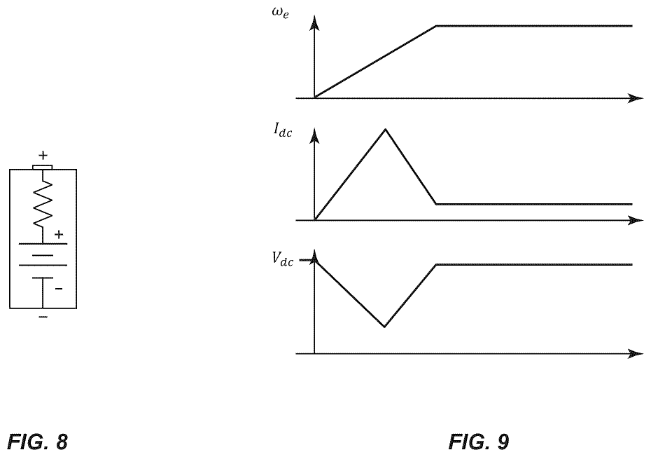

FIG. 8 illustrates a simplified model of the battery 118, which has an almost linear inverse cell voltage to current relationship. That is, the cell voltage decreases (nearly) linearly proportional to load current increase. FIG. 9 illustrates the DC current (I_{dc}) and the DC voltage (V_{dc}) for the simplified battery model during fast start-up acceleration of the PMSM 102, and the corresponding rotor electrical speed ωₑ of the PMSM 102. The battery capacity adjustment factor feature described herein allows the demand on the battery 118 to gradually adjust based on the ability of the battery 118 to supply the PMSM 102.

Although the present disclosure is not so limited, the following numbered examples demonstrate one or more aspects of the disclosure.
Example 1. A controller for a battery-powered PMSM (permanent magnet synchronous motor), the controller comprising: a first controller configured to generate a flux generating voltage reference for the PMSM; a second controller configured to generate a torque generating voltage reference for the PMSM; and a battery capacity adjustment factor configured to adjust the flux generating voltage reference and the torque generating voltage reference, based on capacity of the battery.
Example 2. The controller of example 1, wherein the battery capacity adjustment factor is calculated as a measured voltage of the battery divided by a nominal voltage of the battery.
Example 3. The controller of example 1 or 2, wherein the flux generating voltage reference is multiplied by the battery capacity adjustment factor to adjust the flux generating voltage reference, and wherein the torque generating voltage reference is multiplied by the battery capacity adjustment factor to adjust the torque generating voltage reference.
Example 4. The controller of any of examples 1 through 3, further comprising: a rotor position estimator configured to estimate a rotor electrical angle and a rotor electrical speed of the PMSM, based on the adjusted flux generating voltage reference, the adjusted torque generating voltage reference, a flux generating current feedback for the PMSM, and a torque generating current feedback for the PMSM.
Example 5. The controller of example 4, wherein the rotor position estimator comprises a speed feedforward term.
Example 6. The controller of example 5, wherein the speed feedforward term includes a weighting factor that is in a range of zero to less than one.
Example 7. The controller of example 6, wherein the weighting factor is user configurable.
Example 8. The controller of any of examples 5 through 7, wherein the speed feedforward term comprises a dynamic component calculated based on the adjusted torque generating voltage reference, a phase resistance of the PMSM, the torque generating current feedback, the rotor electrical speed estimate, a synchronous inductance of the PMSM, the flux generating current feedback, and a permanent magnet flux linkage constant for the PMSM, and wherein the dynamic component is weighted by the weighting factor.
Example 9. The controller of any of examples 5 through 7, wherein the speed feedforward term comprises a dynamic component calculated based on a stator input voltage estimate for the PMSM, a phase resistance of the PMSM, a stator current feedback for the PMSM, a stator inductance of the PMSM, and a permanent magnet flux linkage constant for the PMSM, and wherein the dynamic component is weighted by the weighting factor.
Example 10. The controller of example 9, wherein the stator input voltage estimate for the PMSM is calculated based on the adjusted flux generating voltage reference, the adjusted torque generating voltage reference, and the battery capacity adjustment factor.
Example 11. A controller for a battery-powered PMSM (permanent magnet synchronous motor), the controller comprising: a rotor position estimator configured to estimate a rotor electrical angle and a rotor electrical speed of the PMSM, based on a flux generating voltage reference for the PMSM, a torque generating voltage reference for the PMSM, a flux generating current feedback for the PMSM, and a torque generating current feedback for the PMSM, wherein the rotor position estimator comprises a speed feedforward term.
Example 12. The controller of example 11, wherein the speed feedforward term includes a weighting factor that is in a range of zero to less than one.
Example 13. The controller of example 12, wherein the weighting factor is user configurable.
Example 14. The controller of any of examples 11 through 13, wherein the speed feedforward term comprises a dynamic component calculated based on the torque generating voltage reference, a phase resistance of the PMSM, the torque generating current feedback, the rotor electrical speed estimate, a synchronous inductance of the PMSM, the flux generating current feedback, and a permanent magnet flux linkage constant for the PMSM.
Example 15. The controller of example 14, wherein the dynamic component is weighted by a weighting factor that is in a range of zero to less than one.
Example 16. The controller of any of examples 11 through 13, wherein the speed feedforward term comprises a dynamic component calculated based on a stator input voltage estimate for the PMSM, a phase resistance of the PMSM, a stator current feedback for the PMSM, a stator inductance of the PMSM, and a permanent magnet flux linkage constant for the PMSM.
Example 17. The controller of example 16, wherein the dynamic component is weighted by a weighting factor that is in a range of zero to less than one.
Example 18. The controller of any of examples 11 through 17, further comprising: a battery capacity adjustment factor configured to adjust the flux generating voltage reference and the torque generating voltage reference, based on capacity of the battery.
Example 19. The controller of example 18, wherein the battery capacity adjustment factor is calculated as a measured voltage of the battery divided by a nominal voltage of the battery.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to cover all possible conjunctive and disjunctive combinations, unless expressly noted otherwise. For example, the expression “A and/or B” should be interpreted to mean only A, only B, or both A and B. The expression “at least one of” should be interpreted in the same manner as “and/or”, unless expressly noted otherwise. For example, the expression “at least one of A and B” should be interpreted to mean only A, only B, or both A and B.

It is to be understood that the features of the various embodiments described herein can be combined with each other, unless specifically noted otherwise.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A controller for a battery-powered PMSM (permanent magnet synchronous motor), the controller comprising:
a first controller configured to generate a flux generating voltage reference for the PMSM;
a second controller configured to generate a torque generating voltage reference for the PMSM; and
a battery capacity adjustment factor configured to adjust the flux generating voltage reference and the torque generating voltage reference, based on capacity of the battery.

2. The controller of claim 1, wherein the battery capacity adjustment factor is calculated as a measured voltage of the battery divided by a nominal voltage of the battery.

3. The controller of claim 1, wherein the flux generating voltage reference is multiplied by the battery capacity adjustment factor to adjust the flux generating voltage reference, and wherein the torque generating voltage reference is multiplied by the battery capacity adjustment factor to adjust the torque generating voltage reference.

4. The controller of claim 1, further comprising:
a rotor position estimator configured to estimate a rotor electrical angle and a rotor electrical speed of the PMSM, based on the adjusted flux generating voltage reference, the adjusted torque generating voltage reference, a flux generating current feedback for the PMSM, and a torque generating current feedback for the PMSM.

5. The controller of claim 4, wherein the rotor position estimator comprises a speed feedforward term.

6. The controller of claim 5, wherein the speed feedforward term includes a weighting factor that is in a range of zero to less than one.

7. The controller of claim 6, wherein the weighting factor is user configurable.

8. The controller of claim 5, wherein the speed feedforward term comprises a dynamic component calculated based on the adjusted torque generating voltage reference, a phase resistance of the PMSM, the torque generating current feedback, the rotor electrical speed estimate, a synchronous inductance of the PMSM, the flux generating current feedback, and a permanent magnet flux linkage constant for the PMSM, and wherein the dynamic component is weighted by the weighting factor.

9. The controller of claim 5, wherein the speed feedforward term comprises a dynamic component calculated based on a stator input voltage estimate for the PMSM, a phase resistance of the PMSM, a stator current feedback for the PMSM, a stator inductance of the PMSM, and a permanent magnet flux linkage constant for the PMSM, and wherein the dynamic component is weighted by the weighting factor.

10. The controller of claim 9, wherein the stator input voltage estimate for the PMSM is calculated based on the adjusted flux generating voltage reference, the adjusted torque generating voltage reference, and the battery capacity adjustment factor.

11. A controller for a battery-powered PMSM (permanent magnet synchronous motor), the controller comprising:
a rotor position estimator configured to estimate a rotor electrical angle and a rotor electrical speed of the PMSM, based on a flux generating voltage reference for the PMSM, a torque generating voltage reference for the PMSM, a flux generating current feedback for the PMSM, and a torque generating current feedback for the PMSM,
wherein the rotor position estimator comprises a speed feedforward term.

12. The controller of claim 11, wherein the speed feedforward term includes a weighting factor that is in a range of zero to less than one.

13. The controller of claim 12, wherein the weighting factor is user configurable.

14. The controller of claim 11, wherein the speed feedforward term comprises a dynamic component calculated based on the torque generating voltage reference, a phase resistance of the PMSM, the torque generating current feedback, the rotor electrical speed estimate, a synchronous inductance of the PMSM, the flux generating current feedback, and a permanent magnet flux linkage constant for the PMSM.

15. The controller of claim 14, wherein the dynamic component is weighted by a weighting factor that is in a range of zero to less than one.

16. The controller of claim 11, wherein the speed feedforward term comprises a dynamic component calculated based on a stator input voltage estimate for the PMSM, a phase resistance of the PMSM, a stator current feedback for the PMSM, a stator inductance of the PMSM, and a permanent magnet flux linkage constant for the PMSM.

17. The controller of claim 16, wherein the dynamic component is weighted by a weighting factor that is in a range of zero to less than one.

18. The controller of claim 11, further comprising:
a battery capacity adjustment factor configured to adjust the flux generating voltage reference and the torque generating voltage reference, based on capacity of the battery.

19. The controller of claim 18, wherein the battery capacity adjustment factor is calculated as a measured voltage of the battery divided by a nominal voltage of the battery.
